(19) United States
(12) Patent Application Publication
(10) Pub. No.: US 2023/0313505 A1
(43) Pub. Date: Oct. 5, 2023

(54) SMART RAIN BARREL GAGE AND RELEASE CONTROLLER

(71) Applicant: University of the District of Columbia, Washington, DC (US)

(72) Inventors: Jaime Rios, Washington, DC (US); Harris Trobman, Rockville, MD (US); Sasan Haghani, Rockville, MD (US); Thabet Kacem, Arlington, VA (US)

(21) Appl. No.: 18/295,186

(22) Filed: Apr. 3, 2023

Related U.S. Application Data
(60) Provisional application No. 63/326,888, filed on Apr. 3, 2022.

(51) Int. Cl. E03B 1/04

(52) U.S. Cl. CPC E03B 1/042; E03B 2001/047

(57) ABSTRACT

An autonomous Internet of Things (IoT) system to track the water level in the rain barrels; an automated smart release system to release water; a) when the barrel is full; b) at preprogramed times or intervals; c) based on the time interval since rain collection, indicating a dry spell, and the need for plants to be watered; and/or d) based on weather forecasts.

### FIELD OF THE INVENTION

The invention is related to rain barrels and the monitoring of water levels in rain barrels.

### BACKGROUND OF THE INVENTION

Rain barrels are generally used to collect rainwater that has fallen on a roof or other surface. Many homeowners like the idea of conserving fresh water and using rainwater for irrigation to place less demand on wells (or other water supplies) during drier periods. It is an environmentally friendly choice.

The following is a list of the benefits of rain barrels:

Save Money. A typical gardener can save as much as 1,300 gallons of water during the growing season. Landscape watering typically accounts for up to 40% of a homeowner's water use during the summer. Using a rain barrel for landscape and garden water needs can significantly reduce a user's water bill.

Reduce Runoff Pollution & Erosion. Runoff from rain picks up soil, oil, pesticides, fertilizers and other contaminates and pushes them to other areas. When these pollutants accumulate, they contribute to algae growth in lakes and alter habitats for fish and other aquatic wildlife which can also make lakes and oceans dangerous for humans and other mammals.

Promote Plant & Soil Health. Rainwater is better for landscaping because it's highly oxygenated and free of salts, fluoride, and inorganic ions. Use of rainwater in a garden also makes plants more drought tolerant.

Conserve Water. Storing rainwater can do a world of good for the environment. A rain barrel can provide an independent source of water in times of mild drought or watering restrictions. The average rainfall of one inch within a 24-hour period can produce more than 700 gallons of water that run off a typical home.

Rain barrels are a widely utilized strategy to mitigate stormwater at homes and in urban centers and towns across the United States. While rain barrels are a very cost effective and feasible option for most homes, they rely on property owners to properly operate and empty the rain barrel to ensure continuous water quality and quantity benefits.

### PRIOR ART

U.S. Pat. No. 8,950,428 by Sly, “Automatic rain barrel” discloses an automatic rain barrel providing the ability to easily use a mix of rainwater and water from another source for tasks such as watering landscaping.

U.S. Pat. No. 8,739,817 by Griffin, et al., “Diverter and lid assembly for use with a rain barrel device and system” discloses a diverter for a rain barrel includes a scoop portion configured to fit within a gutter downspout, a rain barrel fitting portion configured to fluidly attach the scoop portion to the rain barrel, and a wing extending outwardly from the scoop portion to direct a flow of water in the gutter downspout towards the scoop portion.

U.S. Pat. No. 10,285,345 by Gong et al., Irrigation device and system, and method for using the same” discloses an irrigation device, including: a rain barrel; a water pump; a humidity detector; a permeable pipe; a control unit; a first valve; a second valve; a cleaning unit. The permeable pipe includes a plurality of circumferentially distributed bores. The rain barrel, the water pump, the first valve and the permeable pipe are connected sequentially. The humidity detector is adapted to detect a humidity of a green land.

### SUMMARY OF THE INVENTION

This application discloses an autonomous Internet of Things (IoT) system to track the water level in the rain barrels; an automated smart release system to release water a) when the barrel is full; b) at preprogramed times or intervals; c) based on the time interval since rain collection, indicating a dry spell, and the need for plants to be watered; and/or d) based on weather forecasts. The system may also receive commands for the release of water remotely through a web page or mobile app.

The system may be powered by a small commercially available solar panel, or other compact power source, is highly portable and quickly assembled, installed, and connected. The invention allows users to develop a working knowledge of their water catchment and exert control over its release. The direct control over the device empowers users to take an active role in the controlled release of stormwater and the connectivity allows for convenient and time effective remote monitoring and control.

While the invention is described herein in the context of home use, the invention may be easily scaled for large scale farm and other commercial uses.

Accordingly, there is provided according to the invention a rain barrel water level monitor and control device comprising: a microcontroller, a power source connected to said microcontroller; a vertically oriented bar configured to extend into the interior of a rain barrel, a plurality of water level sensors arranged along said vertical oriented bar in electronic communication with said microcontroller, a solenoid-controlled drain valve in electronic communication with said microcontroller; a wireless communication module in electronic communication with said microcontroller and configured to communicate with a remote software client, said remote software client configured to present water level date to a user on a mobile app or web page and to receive user instructions via said mobile app or web page concerning water release from solenoid-controlled drain valve. According to various alternative embodiment the power source may be a solar cell, the plurality of water level sensors may be magnet activated reed switches, the solenoid-controlled drain valve may be in wireless communication with the microcontroller, and/or the microcontroller may be situated within a housing and the vertically oriented bar may be suspended from the housing.

According to further embodiments in combination with any one or more of the above embodiments, the microcontroller may be programmed or commanded to direct the solenoid-controlled drain valve to dispense water from the rain barrel according to a preset schedule, according to predetermined water levels, according to user command via said mobile app or web page, and/or according to weather forecasts.

The system as disclosed herein may be utilized in the manufacture of new rain barrels or be provided as retrofits for existing rain barrels to enhance water optimization and ensure effective stormwater utilization.

### BRIEF DESCRIPTION OF DRAWINGS

FIG. 1 is schematic overview of a rain barrel monitoring device according to an embodiment of the invention.

FIG. 2 shows the components of a rain barrel monitoring device according to an embodiment of the invention.

FIG. 3 is a side view of a rain barrel monitoring device according to an embodiment of the invention.

FIG. 4 is a representation of autonomous features of a rain barrel monitoring device according to an embodiment of the invention.

### DETAILED DESCRIPTION OF THE INVENTION

For a system to mitigate stormwater runoff, there must be sufficient room available in the tank to store future runoff events. A smart rain barrel monitor is presented here that provides an autonomous Internet of Things (IoT) system to track the water level in the rain barrels and make certain they have sufficient storage capacity either via automated alerts to remind the property owner/facility manager to drain the barrel(s) and/or via a fully automated smart release system. The cost effective and replicable devices according to the invention, provided as original equipment with new rain barrels or as retrofits for existing rain barrels, enhance water optimization and ensure effective stormwater utilization.

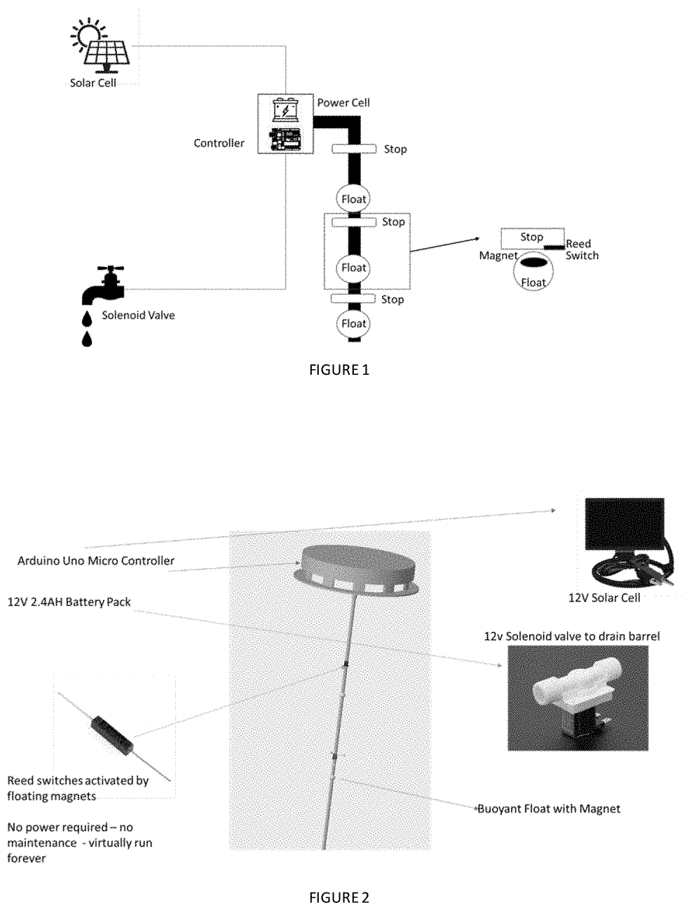

Referring to FIG. 1, systems overview and principles of operation are presented. The invention is preferably powered by a small portable renewable/inexhaustible power source, such as a solar cell. Other portable, renewable power sources may be used. Of course, as noted above, appropriately-sized power sources may be used for large and/or commercial operations. A power cell and microcontroller are coupled to the power source in a control housing at the top of the device, which control housing preferable rests on or above the top of the rain barrel (not shown). A vertical element, such as a rod or dowel or bar is connected to the control housing and descends into the rain barrel. A series of stops and floats are mounted on the vertical element. The microcontroller and power cell are also electronically connected to a solenoid valve for draining/distributing the water in the water barrel.

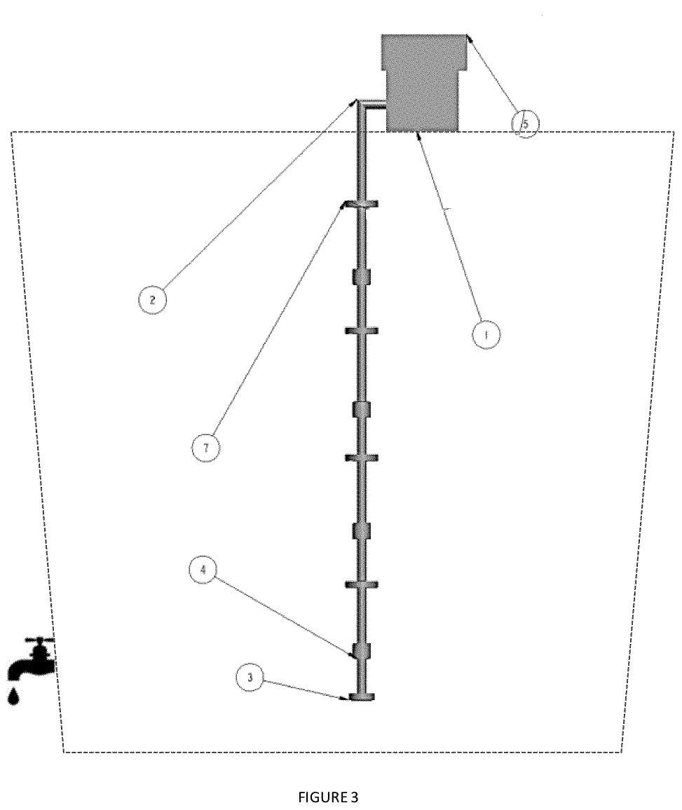

FIG. 2 shows a more detailed example of a smart rain barrel monitor according to an embodiment of the invention. According to a preferred embodiment, the microcontroller is an Arduino microcontroller, although any suitable microcontroller will do. A solar panel and 12 v solar cell are provided to power the microcontroller, and a 12 volt 2.4 amp battery pack is provided to power a 12 volt solenoid drain valve preferably under wireless control of the microcontroller. According to a preferred embodiment, the water level sensors may be reed switches activated by magnets attached to or contained within buoyant floats, although any suitable sensor that can detect or reflect water level may be used.

FIG. 3 shows an external side view of a prototype smart rain barrel monitor according to an embodiment of the invention including controller housing/box 1 with lid 5 containing microcontroller and power cell (not shown), vertical element or “down stem” 2 with end stop 3, floats 4 and sensors or “stops” 7. Referring to the exemplary embodiments, as the water level increases in the rain barrel, it gradually raises each of the floating sensors to indicate the height of the water level in the rain barrel.

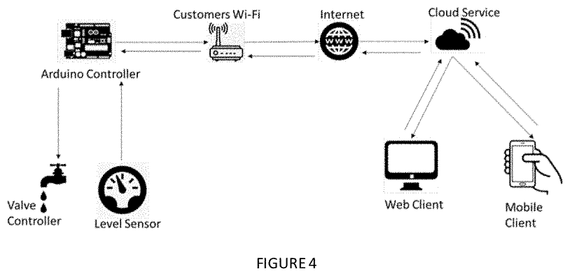

According to a preferred embodiment illustrated in FIG. 4, the microcontroller may be connected by Wi-Fi to a cloud provider which in turn facilitates communication to a mobile app or website giving the user constant access to both water level data and control over the solenoid actuated valve. Accordingly, the invention provides a smart rain barrel monitor and control device that allows the user to remotely track the water level in the rain barrels; and program the microcontroller, for example using a mobile app or a web interface/client to release water; a) when the barrel is full; b) at preprogramed times or intervals; c) based on the time interval since rain collection, indicating a dry spell, and the need for plants to be watered; and/or based on weather forecasts. Specifically with respect to weather forecasts, the system may receive or retrieve digital weather reports, including predictions of various amounts of rain as far as 7-10 days or more in the future, from digital sources of weather reports and forecasts. Based on such forecasts, the system may be programmed to release (or not release) water from the rain barrel prior to the day(s) of predicted rain based on the amount of water in the barrel, based on the amount of rain forecast, based on the confidence level of the forecast and/or based on the area of the surface from which the rain barrel received rain water.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

1. A rain barrel water level monitor and control device comprising:
a microcontroller,
a power source connected to said microcontroller;
a vertically oriented bar configured to extend into the interior of a rain barrel,
a plurality of water level sensors arranged along said vertical oriented bar in electronic communication with said microcontroller,
a solenoid-controlled drain valve in electronic communication with said microcontroller;
a wireless communication module in electronic communication with said microcontroller and configured to communicate with a remote software client, said remote software client configured to present water level date to a user on a mobile app or web page and to receive user instructions via said mobile app or web page concerning water release from solenoid-controlled drain valve.

2. A rain barrel water level monitor and control device according to claim 1, wherein said power source is a solar cell.

3. A rain barrel water level monitor and control device according to claim 1, wherein said plurality of water level sensors are magnet activated reed switches.

4. A rain barrel water level monitor and control device according to claim 1, wherein said solenoid-controlled drain valve is in wireless communication with said microcontroller.

5. A rain barrel water level monitor and control device according to claim 1, wherein said microcontroller is situated within a housing and said vertically oriented bar is suspended from said housing.

6. A rain barrel water level monitor and control device according to claim 1, wherein said microcontroller may be programmed or commanded to direct said solenoid-controlled drain valve to dispense water from said rain barrel according to a preset schedule, according to predetermined water levels, according to user command via said mobile app or web page, and/or according to weather forecasts.
